(19) United States
(12) Patent Application Publication
(10) Pub. No.: US 2024/0370737 A1
(43) Pub. Date: Nov. 7, 2024

(54) DEVELOPING MACHINE-LEARNING MODELS

(71) Applicant: Telefonaktiebolaget LM Ericsson (publ), Stockholm (SE)

(72) Inventors: Hannes LARSSON, Solna (SE); Jalil TAGHIA, Stockholm (SE); Masoumeh EBRAHIMI, Solna (SE); Carmen Lee ALTMANN, Täby (SE); Andreas JOHNSSON, Uppsala (SE); Farnaz MORADI, Bromma (SE)

(73) Assignee: Telefonaktiebolaget LM Ericsson (publ), Stockholm (SE)

(21) Appl. No.: 18/288,651

(22) PCT Filed: Apr. 29, 2021
(86) PCT No.: PCT/EP2021/061245

§ 371 Date: Oct. 27, 2023

(51) Int. Cl. G06N 3/098

(52) U.S. Cl. CPC G06N 3/098

(57) ABSTRACT

Methods and leader computing devices for developing machine-learning models. A method comprises receiving, at a leader computing device from each of a plurality of worker computing devices, weights and model architecture information for part of a trained ML model. The method further comprises determining, at the leader computing device, a common portion of the parts of trained ML models that is useable by all of the plurality of worker computing devices, and generating, at the leader computing device, an updated common portion of the ML model using the common portion of the parts of trained ML models and the weights and model architecture information from each of the plurality of worker computing devices. The method further comprises initiating transmission of the updated common portion of the ML model to the worker computing devices.

### TECHNICAL FIELD

Embodiments described herein relate to methods and apparatus for developing a machine-learning model.

### BACKGROUND

In a variety of environments, machine learning (ML) methods may be utilised in a number of systems which are similar but not (necessarily) identical. In distributed environments such as mobile telecommunication networks, distributed cloud computing networks, and Internet of Things (IoT) networks there are typically many devices that perform similar tasks but do not necessarily have the same configuration, for example, the same underlying hardware and measurement capabilities. Distributed networks and applications executed on them commonly use container-based environments, supporting the use of cloud native application frameworks. In order to utilise cloud native application frameworks, applications should be infrastructure agnostic, meaning that regardless of the infrastructure, an application should execute in the same way.

A further implementation of ML in a number of systems which are similar but not (necessarily) identical is in autonomous data centres. Autonomous data centres are typically intended to operate for a given time frame, commonly of the order of several years, with no human interaction. During the given time frame, a data centre should continue to operate despite the failure of components within the data centre and/or measurement tools used to monitor the data centre. As a consequence of this continued operation, the infrastructure and available measurement tools for a given data centre may vary from those used by a further data centre, even where the two data centres were initially identical.

There are difficulties associated with efficiently training and using ML models that can operate in dynamic environments such as those discussed above, primarily due to the possible changes in input features and execution environments that ML models operating in said dynamic environments may be subjected to, and which must therefore be taken into account by the ML models. For ML in dynamic environments such as those discussed above, typically a ML model is trained for a specific task using infrastructure data. Training models for specific tasks is clearly not infrastructure agnostic; the resulting ML models must be adapted to the specific infrastructure for every execution environment, which may be very labour intensive and inefficient. Typically, ML models may be developed for use in distributed environments using distributed learning techniques, such as federated learning, transfer learning and split learning, however it can be difficult to take into account dynamic environments using these techniques.

In federated learning (FL), an initial ML model (potentially including a fixed architecture, that is, fixed numbers of neurons in layers and fixed connections between neurons) may be distributed by a leader node or computing device (also known as a centralized or global node) to a plurality of worker nodes or computing devices (also known as follower or local nodes) and trained in each of the worker nodes using a dataset that is locally available at the worker node. The dataset may be locally compiled at the worker node, for example, using data collected at the worker node from the worker node's environment. The ML models may be trained at the worker nodes for a number of epochs (that is, learning cycles), resulting in trained (local) ML models that typically vary between worker nodes (for example, the weights assigned to connections between neurons differ between the different trained local ML models). The trained ML models from the worker nodes may then be sent back to the leader node and combined to produce a collaboratively trained (global) ML model. This collaboratively trained ML model may then be used, and/or may be sent back to each of the worker nodes for further training.

FL allows updated (local) ML models to be trained at worker nodes within a network, where these updated ML models have been trained using data that may not have been communicated to, and may not be known to, the centralized node (where the centralized node may provide an initial global ML model). In other words, an updated ML model may be trained locally at a worker node using a dataset that is only accessible locally at the worker node and may not be accessible from other nodes (other worker nodes or centralized nodes) within the network.

A specialised form of FL is vertical federated learning (VFL), as discussed in “Federated machine learning: Concept and applications” by Yang, Q. et al., ACM Trans. Intell. Syst. Technol., Vol. 10, No. 2, Article 12, available at https://arxiv.org/pdf/1902.04885.pdf as of 17 Mar. 2021. In VFL, different worker nodes have data with different features. Rather than combining the ML models trained by the different worker nodes, features from the ML models are combined. VFL allows workers with different feature spaces to collaborate. However, in order to allow features to be correctly combined, the worker nodes involved in the VFL system are required to utilise consistent sample identifiers. As an example of the use of consistent sample identifiers; in a scenario where several workers have data records related to the performance of a number of people in different tasks, worker A may have data relating to a first task and worker B may have data relating to a second task. If consistent sample identifiers are used, the data from worker A and B could be matched to enable data relating to the performance of a given person in the first and second tasks to be combined.

In transfer learning, a ML model is first trained in a source domain and then transferred to the target domain. A domain is defined by its data and the related tasks, in relation to a specific data set. When two or more domains have the same features, the domains are said to be homogenous. In the case where the domains have different features, they are said to be heterogenous. Distributed systems with different underlying hardware and measurement capabilities are the example of heterogenous domains. Use of transfer learning between heterogenous domains typically results in suboptimal results when compared to the use of transfer learning between homogeneous domains; the transferred ML model may not correctly operate using the features of the target domain that differ from those the ML model was trained using.

Split learning is discussed in “Split learning for health: Distributed deep learning without sharing raw patient data” by Vepakomma, P. et al., 32nd Conference on Neural Information Processing Systems (NIPS 2018), Montreal, Canada, available at https://arxiv.org/pdf/1812.00564.pdf as of 17 Mar. 2021. In split learning, each worker node trains a partial neural network up to a specific layer, which may be referred to as the cut layer. The outputs of the cut layer are sent to the leader node. The leader node completes the training, completing the forward propagation and back propagation by computing the gradients from the last layer until the cut layer. The gradients at the cut layer are sent back to the workers, then the remainder of the back propagation is completed by the individual worker nodes. The process is continued until convergence.

Using standard (non-vertical) FL puts a restriction on network architectures and input features. The architectures of the neural networks must be the same across all worker nodes, and the input features must have a homogenous meaning across all worker nodes. That is, the leader node assumes that the feature representations, or input features, are the same in all worker nodes. In scenarios with, by way of example; data centres composed of different numbers of machines, base stations with different hardware or software configurations and so on, the input features are not the same. Currently, making an efficient use of different features is possible using manual pre-processing of the data, which is a costly step both in terms of time and manual labour. VFL assumes consistent sample identification among the different worker nodes (as discussed above). Accordingly, VFL does not effectively deal with the problem of having different sample identification among the worker nodes while having different input feature representations.

In split learning, the error back propagation is partly carried out on the leader node. Accordingly, for each epoch, each worker node needs to communicate with the leader node, typically resulting in a high volume of inter node communications. As a comparison, in standard FL, the full training including forward propagation and backward propagation is carried out locally on the worker nodes, which allows worker nodes to train locally for several epochs before sharing updates with the leader node. Standard FL therefore typically requires considerably lower volumes of communications than split learning. A further limitation of split learning is the fact that the cut layer is being sent to the leader node, this is less privacy preserving than just sending updated weights as may be the case with FL systems.

The existing solutions, such as VFL and split learning techniques, do not effectively account for dynamic execution environments. For example, in split learning the size of the cut layer is fixed initially and remains fixed throughout; this may be too restrictive in highly dynamic execution environments, such as autonomous data centres in which available components may vary as discussed above. An equivalent example is the long-term deployment of edge nodes where measurement capabilities or parts of the hardware may break down while the node is operational (without maintenance). Non-availability of components imposes a substantial change in the environment where only the available features change.

### SUMMARY

It is an object of the present disclosure to provide methods, apparatuses and computer readable media which at least partially address one or more of the challenges discussed above. In particular, it is an object of the present disclosure to provide ML model development that may effectively take into account the dynamic execution environments by actively monitoring for changes in the execution environment and proactively adjusting the architecture accordingly.

The present disclosure provides methods for developing Machine Learning (ML) models. A method comprises receiving, at a leader computing device from each of a plurality of worker computing devices, weights and model architecture information for part of a trained ML model (for example, a locally trained ML model). The method further comprises determining, at the leader computing device, a common portion of the parts of trained ML models that is useable by all of the plurality of worker computing devices. The method also comprises generating, at the leader computing device, an updated common (global) portion of the ML model using the weights and model architecture information from each of the plurality of worker computing devices, and initiating transmission of the updated (global) common portion of the ML model to the worker computing devices. The method may facilitate federation between worker computing devices using heterogenous ML models, and may also support dynamic adaptation to take into account changes in operating environments and/or computing devices.

Prior to receiving the weights and model architecture information for the parts of trained ML models from the worker computing devices the leader computing device may receive, from the plurality of worker computing devices, ML model architecture privacy information. The leader computing device may further determine a maximum common portion of the ML model that is useable by all of the plurality of worker computing devices, using the ML model architecture privacy information, and initiate transmission of initialization information for the maximum common portion of the ML model to all of the plurality of worker computing devices. By initialising the worker computing devices using a suitable maximum common portion the method may support compatibility between the different ML models trained by the worker computing devices.

The step of determining the common portion of the ML models may comprise detecting a variation in a model architecture from among the model architectures of the trained ML models. If a variation is detected, the updated common portion of the ML model distributed to the worker computing devices may comprise weights and model architecture information. If a variation is not detected, the updated common portion of the ML model distributed to the worker computing devices comprises may comprise weights. In this way, the common portion can be adapted as necessary based on variation in trained worker ML models.

Each of the worker computing devices may use the updated common portion of the ML model as part of a worker specific ML model, wherein each worker specific ML model is used to provide suggested actions for an environment. Further, the environment may be one or more base stations in a communications network, or one or more servers in a data centre. The method may be particularly well suited to use in environments that may vary over time, such as base stations in a network or servers in a data centre.

The present disclosure also provides leader computing devices configured to develop Machine Learning (ML) models. A leader computing device comprises processing circuitry and a memory containing instructions executable by the processing circuitry. The leader computing device is operable to receive, from each of a plurality of worker computing devices, weights and model architecture information for part of a trained ML model. The leader computing device is further operable to determine a common portion of the parts of trained ML models that is useable by all of the plurality of worker computing devices. The leader is also operable to generate an updated common portion of the ML model using the weights and model architecture information from each of the plurality of worker computing devices, and initiate transmission of the updated common portion of the ML model to the worker computing devices. The leader node may provide some or all of the advantages discussed above in the context of the method.

### BRIEF DESCRIPTION OF DRAWINGS

The present disclosure is described, by way of example only, with reference to the following figures, in which:

FIG. 1 is a flowchart of a method in accordance with embodiments;

FIGS. 2A and 2B are schematic diagrams of ML systems in accordance with embodiments;

FIG. 3 is a schematic diagram of an example of a ML model;

FIG. 4 is a schematic illustration of the selection of the maximum common portion;

FIGS. 5A and 5B are a flowchart showing an overview of a process for developing a ML model in accordance with embodiments; and

FIGS. 6A, 6B and 6C are a signalling diagram of a process for developing a ML model in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

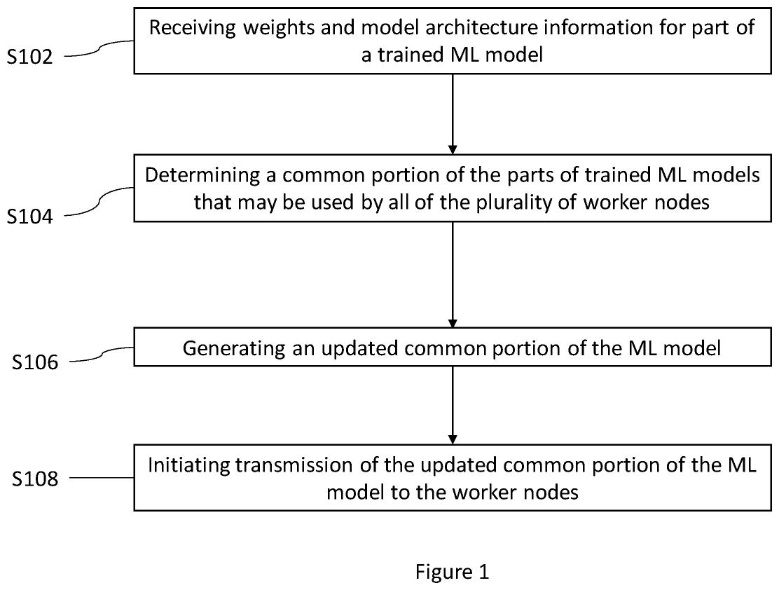

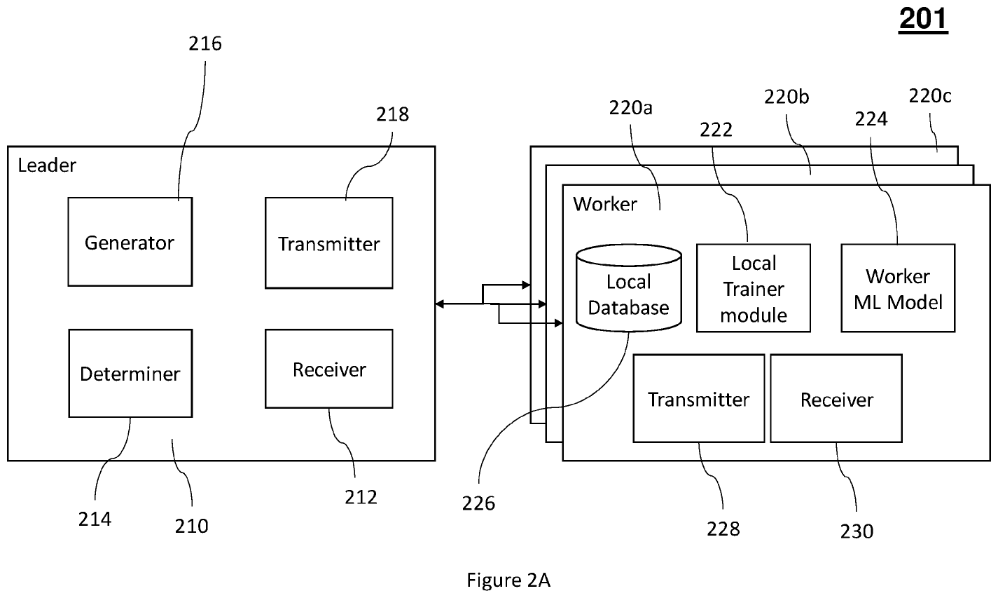

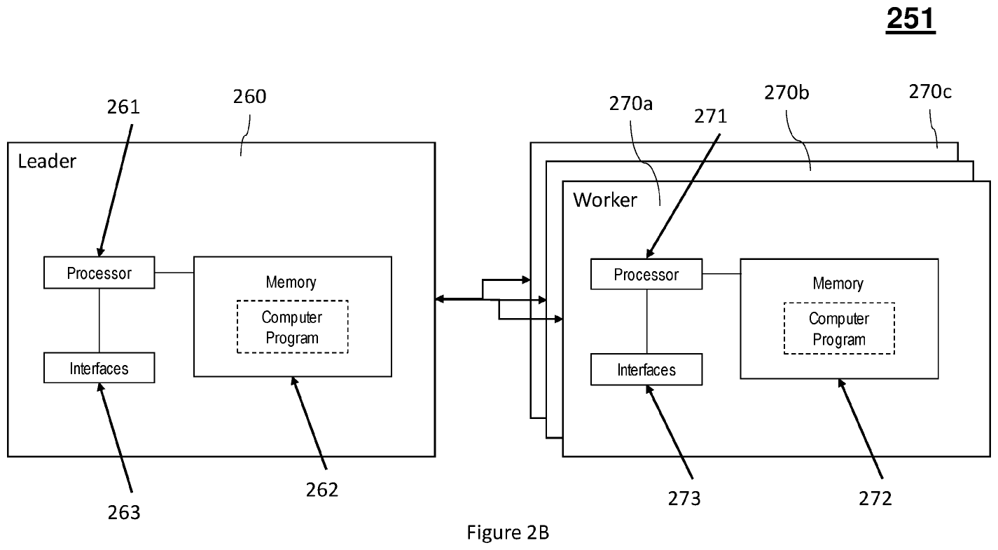

Embodiments of the present disclosure provide methods for developing machine learning (ML) models using collaborative learning between a leader node (which may also be referred to as a leader computing device or a global node) and a plurality of worker nodes (which may also be referred to as a worker computing device or a local node). A method in accordance with embodiments is illustrated by FIG. 1, which is a flow chart showing process steps of a method for developing a ML model. FIG. 2A and FIG. 2B are schematic overviews of ML systems 201, 251, which may perform methods in accordance with embodiments. The ML system 201 of FIG. 2A comprises a single leader node 210 and a plurality of worker nodes 220a, 220b and 220c (collectively referred to using the reference sign 220). The ML system 251 of FIG. 2B comprises a single leader node 260 and a plurality of worker nodes 270a, 270b and 270c (collectively referred to using the reference sign 270). The ML systems 201, 251 of FIG. 2A and FIG. 2B both show three worker nodes 220, 270; those skilled in the art will appreciate that larger or smaller numbers of worker nodes may be used. Some ML systems may also incorporate plural leader nodes 210, 260, which may be of particular use when modelling very complex environments.

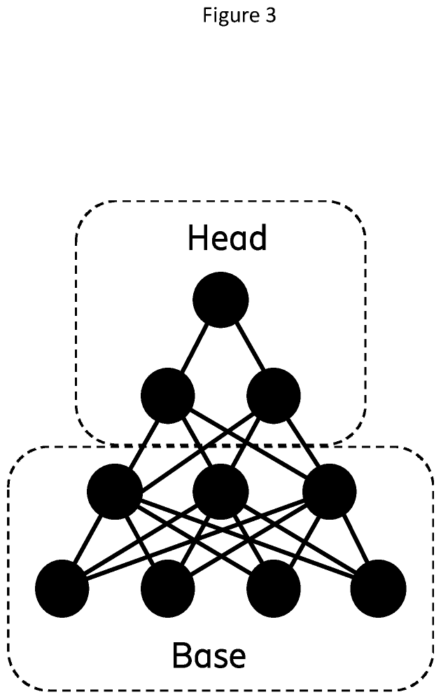

Embodiments may support collaborative learning between heterogenous components, and also between components that vary overtime. In particular, embodiments may utilise separate training for head and base portions of ML models. FIG. 3 is a schematic diagram of an example of a ML model, specifically a neural network. The term “base” refers to the first layer(s) in a neural network, including at least the input layer and potentially also including further layers. The term ‘head’ refers to the last layer(s) of the neural network, including at least the output layer and potentially also including further layers. In the example shown in FIG. 3, the base includes the input layer and one further layer, and the head includes the output layer and one further layer. The whole neural network (ML model), for a specific worker, is the combination of the base and the head. According to embodiments, the head may be generated by the leader node and shared with the worker nodes, and the base may be retained by (and potentially unique to) each of the worker nodes. Each layer of the neural network contains a number of neurons; the number of layers, the number of neurons in each layer and the connections between the neurons are referred to herein as the architecture information of the neural network (an example of a ML model). The weights assigned to the connections are referred to herein collectively as the weights of the neural network.

Typically, each of the worker nodes 220, 270 may communicate with the leader node 210, 260, but there are no direct lines of communication between worker nodes 220, 270. The worker nodes may desire to retain control of potentially sensitive data (and may, for example, be operated by different network operators in a communication network); allowing the worker nodes 220, 270 to retain control of a portion of the ML model may help address security issues (as may result if all ML model information were shared between worker nodes). In some embodiments the leader node and a worker node may be co-located, that is, may be contained within the same physical apparatus. However, typically the leader node and worker nodes are located separately from one another, and communicate with one another using a suitable communication means (such as a wireless communications system, wired communications system, and so on).

In some embodiments the ML system 201, 251 may form part of a wireless communication network such as a 3^{rd} Generation Partnership Project (3GPP), 4^{th} Generation (4G) or 5^{th} Generation (5G) network. Where the ML system 201, 251 forms part of a wireless communications network, the leader node and worker nodes may be co-located and/or may be located in suitable components of the network. In some embodiments, the leader node 210, 260 may form part of a Core Network Node (CNN), and the worker nodes 220, 270 may each form part of a base station (which may be 4th Generation, 4G, Evolved Node Bs, eNB, or 5th Generation, 5G, next Generation Node Bs, gNBs, for example). Alternatively, the ML system 201, 251 may form part of a data centre, with each worker node forming part of a server and the leader node forming part of a data centre controller. In some embodiments the ML system 201, 251 may form part of an Internet of Things (IoT) system, that is, a system comprising one or more IoT devices. Where the ML system 201, 251 forms part of an IoT system, the leader node and worker nodes may be co-located and/or may be located in suitable components of the network. In some embodiments, the leader and/or worker nodes may provide access points for one or more IoT devices to a network.

As shown in step S102 of FIG. 1 the method comprises receiving, at a leader node 210, 260, from each of a plurality of worker nodes 220, 270, weights and model architecture information for part of a trained (local) ML model. The portion of the trained (local) ML model shared by each worker node with the leader node is determined by the worker node. In some embodiments, the worker node may be willing to share the entire trained ML model (from input layer to output layer) with the leader node; this may be the case where all of the worker nodes and the leader node are operated by the same network operator, for example. Where a worker node is willing to share its entire trained ML model with the leader node, the part of the local ML model for which weights and model architecture information is received may be the entirety of the ML model. Typically, each worker node is willing to share a part of its local ML model that is less than the entirety of the local ML model with the leader node; accordingly the worker node shares weights and model architecture information for some but not all of its local ML model.

The weights and model architecture information that the leader node receives from each of the plurality of worker nodes is weights and model architecture information of part of a trained local ML model; the ML model may be referred to as a local ML model as it has been trained by the worker node and is therefore unique to the worker node. The data used in the training may be private to the given worker node; this is particularly likely to be the case where the plurality of worker nodes providing data to the leader node comprises worker nodes operated by different operators (in the context of a communications network, the worker nodes may be base stations operated by different network operators, for example). Each of the plurality of worker nodes may be required to share at least weights and model architecture information for the output layer of its trained (local) ML model. The amount of its trained ML model that each of the worker nodes among the plurality of worker nodes is willing to share may be determined by the worker node (or the operator of the worker node), and may be determined based on the relative privacy of the data used. Further the amount of each of the worker nodes is willing to share may vary with time. Worker nodes 220 may train a worker ML model 224 using a local trainer module 222 and based on data stored in a local database 226. The results of this training may then be sent to the leader node 210 using a transmitter 228, all as shown in FIG. 2A. Alternatively, worker node 270 may train a worker ML model using a computer program stored in a memory 272, executed by a processor 271, and the results of this training may then be sent to a leader node 260 using interfaces 273, all as shown in FIG. 2B. The receiving of the weight and model architecture information from each of the plurality of worker nodes may, for example, be performed by a receiver 212 of the leader node 210 as shown in FIG. 2A, or by a computer program stored in a memory 262, executed by a processor 261 in conjunction with one or more interfaces 263 (wherein the interfaces 263 may comprise a receiver) as shown in FIG. 2B.

When the weights and model architecture information for part of a trained (local) ML model has been received by the leader node from each of the plurality of worker nodes, the leader node then determines a common portion of the parts of trained (local) ML models that is useable by all of the plurality of worker nodes, as shown in step S104. The common portion will ultimately result in the head of the ML models used by the worker nodes. Returning to FIG. 3, the head (comprising the output layer) of the ML models used by each of the worker nodes will ultimately be the same, while the bases (each comprising an input layer) of the ML models used by each of the worker nodes will differ from one another. As the head is common across all of the ML models of the worker nodes, the bases of each of the ML models used by each of the worker nodes should map to the same latent space; essentially the bases should represent input data in the same way. As a result, bases (in different worker nodes) having different model architectures may utilise the same head, and the head may therefore be developed collaboratively using data from the various worker nodes. For each ML model used by a worker node; the input into the base is the data input into the ML model, the output from the base is the input into the head, and the output from the head is the output of the ML model. The common portion of the parts of trained (local) ML models may be determined by the leader node based on the weights and model architecture information received from the plurality of worker nodes. In particular, the leader node may detect a variation in model architecture from among the model architectures of the trained ML models. Here, a variation in model architecture may be detected if the model architecture information provided by a given worker node indicates a different model architecture to the model architecture the leader node previously understood the given worker node to be using. The leader node may specifically check model architecture information received in step S102 in order to detect changes. Additionally or alternatively, the leader node may receive metadata from one or more of the worker nodes.

Where the leader node receives metadata from a worker node, this metadata may include a variety of different information potentially useful to the leader node. Examples of information that may be included in the metadata include: resource availability information indicating what resources are available in the worker node for computing and updating ML models, validation information indicating the performance of the full ML models in the worker node, updated model architecture privacy information indicating that the worker node is willing to share more or less of its trained local ML model than previously, and notification of a variation in a model architecture indicating that the model architecture used by the worker node has changed. Where each of the plurality of worker nodes indicate to the leader node (for example, in metadata) that the model architecture used by the worker node has changed, it may not be necessary for the leader node itself to perform change detection using the model architecture information provided in step S102.

Factors which may influence the determination of the common portion of the parts of trained local ML models include the similarities or disparities between the data distributions used by different worker nodes, features, gradients of weights (or the weights themselves, depending on what is being sent) or measurement tools in the different worker nodes. Where the worker nodes have similar data distributions, features, weights, gradients of weights, measurement tools and so on, the common portion may be larger than where these factors are different. Each of the listed factors may change dynamically as the data, measurement tools or available resources in the worker nodes change, so the common portion may vary in size between rounds of training.

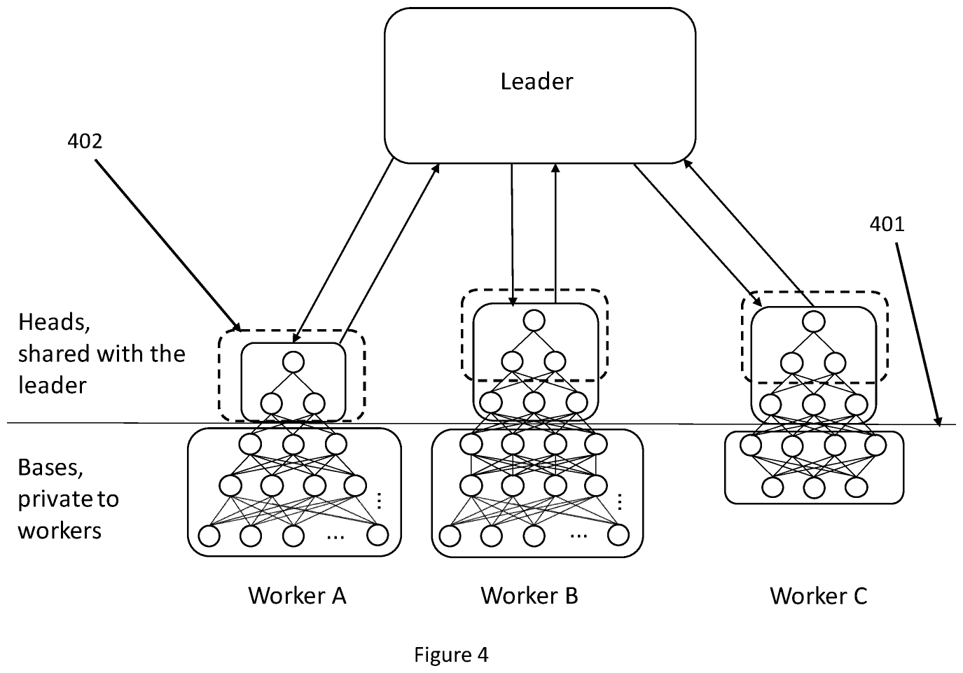

The common portion of the parts of trained local ML models is limited to a maximum common portion, which is based on the maximum number of layers (including the output layer, so the head portion) that each of the worker nodes is willing to share. Essentially, the maximum common portion is the maximum part of its trained local ML model that the most reticent of the worker nodes is willing to share. The selection of the maximum common portion in accordance with embodiments is illustrated schematically in FIG. 4. In the example shown in FIG. 4, the plurality of worker nodes comprises worker nodes A, B and C (in embodiments the plurality of worker nodes may comprise various numbers of worker nodes, typically more than 3 worker nodes). The portion of its trained local ML model each worker node is willing to share is the head of the ML model; the portion above the cut line 401 in the FIG. 4 diagram. The portion of its trained local ML model that each worker node keeps private (does not share) is the base of the ML model; the portion below the cut line 401 in FIG. 4. Worker node A is willing to share the output layer of its ML model and 1 further layer, worker node B is willing to share the output layer of its ML model and 2 further layers, and worker node C is willing to share the output layer of its ML model and 2 further layers. As shown in FIG. 4, the architecture of the top 3 layers of the ML models in all three worker nodes is the same, however as worker node A is only willing to share the output layer and one further layer (that is, the top 2 layers), the leader node only has knowledge of the top two layers of all the worker node trained local ML models. That is, the leader node has knowledge of the top three layers of the ML models of worker nodes B and C, but only the top two layers of the ML model of worker node A. FIG. 4 also shows how the architecture of the bases of the ML models in the various worker nodes may differ from one another. The leader node selects the maximum common portion based on the portions of their respective trained local ML models the worker nodes are willing to share. The maximum common portion is indicated by the dashed box 402 in FIG. 4.

In the example shown in FIG. 4, worker node A is the most reticent of the worker nodes (willing to share the least of its trained local ML model); worker node A is willing to share the top 2 layers of its trained local ML model therefore this is the maximum common portion. As explained above, the worker nodes may vary the portion of their ML model they are willing to share (and may indicate variation by sending metadata including updated model architecture privacy information), and accordingly the maximum common portion may vary over time. Continuing with the example above, if worker node A subsequently indicated that it was willing to share the output layer of its trained local ML model and 3 further layers, then the revised maximum common portion would be set by the most reticent of the worker nodes (now worker node B or C, both are equally reticent) at 3 layers. The determination of the common portion that may be used by all of the plurality of worker nodes may, for example, be performed by a determiner 214 of the leader node 210 as shown in FIG. 2A, or by a computer program stored in a memory 262, executed by a processor 261 in conjunction with one or more interfaces 263 as shown in FIG. 2B.

When the common portion of the parts of trained local ML models that is useable by all of the plurality of worker nodes has been determined, an updated common (global) portion of ML model is then generated using the weights and model architecture information from each of the plurality of worker nodes (see step S106). The weights and model architecture information relating to the determined common portion of the parts of trained local ML models, from each of the plurality of worker nodes, is combined using any suitable method in order to generate the updated common portion. An example of a suitable method is federated averaging; those skilled in the art will be aware of suitable means for combining weights and model architecture information. The process for generating the updated common portion is similar to the way in which an updated ML model is generated in a standard FL system, save that the updated common portion is a part of a ML model, rather than the entire model. Accordingly, the results of the training performed by the worker nodes are used to generate the updated common portion. The generation of the updated common portion that may be used by all of the plurality of worker nodes may, for example, be performed by a generator 216 of the leader node 210 as shown in FIG. 2A, or by a computer program stored in a memory 262, executed by a processor 261 in conjunction with one or more interfaces 263 as shown in FIG. 2B.

Transmission of the generated updated common (global) portion to all of the plurality of worker nodes is then initiated, as shown in step S108. The transmission may be performed by the leader node, or the leader node may instruct transmission by a further component. Where it is determined that there is no variation in model architectures used by the worker nodes, the updated common portion may simply comprise updated weights for use with the existing ML model architecture in the worker nodes. Alternatively, where it is determined that there is variation in model architectures of trained local ML models used by the worker nodes, the updated common (global) portion may comprise updated weights and updated model architecture information to be used by the worker nodes. The initiation of the transmission of the updated common (global) portion to the plurality of worker nodes may, for example, be performed by a transmitter 218 of the leader node 210 as shown in FIG. 2A, or by a computer program stored in a memory 262, executed by a processor 261 in conjunction with one or more interfaces 263 (which may include a transmitter) as shown in FIG. 2B. The updated common (global) portion may be received, for example, by worker node 220 using receiver 230, or by worker node 270 using interfaces 273.

Once the worker nodes have received the updated common (global) portion, each worker node may then use the updated common (global) portion in conjunction with the private portion of the local ML model retained on each worker node to generate a complete worker node specific (local) ML model. The specific local ML models of each of the plurality of worker nodes may then be used to provide suggested actions for an environment. As will be appreciated, the nature of the suggested actions is dependent upon the environment which the local ML model is used to simulate. Taking the example wherein the environment is a communications network wherein each worker node forms part of a base station, the suggested actions may comprise, for example, rerouting or dropping traffic or reprioritising certain traffic. In the further example wherein the environment is a data centre and each worker node forms part of a server, the suggested actions may comprise transferring data between servers, duplicating or deleting data, activating backup servers, and so on. According to some embodiments, the method may further comprise implementing a suggested action, that is, modifying the environment based on the suggested actions. Additionally or alternatively, the worker nodes may complete a further round of training of the specific local ML models, and then send weights and model architecture information following the further training of the local ML models to the leader node such that a further updated (global) common portion may be generated as shown in FIG. 1.

The method shown in FIG. 1 and described above may be used to provide updated common portions. Prior to performing any local ML model training at the plurality of worker nodes, the method may further comprise initialising the development of the ML model. In order to initialise the development process, each of the plurality of worker nodes may send local ML model architecture privacy information to the leader node. The local ML model architecture privacy information for each worker node indicates to the leader node a portion of local ML model architecture which that worker node is willing to share; this portion includes the output layer of the local ML model and may include further layers. At the initialisation stage the worker nodes have not trained their local ML models, so only the architecture privacy information (and not weights information) is sent to the leader node. The leader node may use the local ML model architecture privacy information to determine a maximum common portion of the ML model (as discussed above) that is usable by all of the worker nodes. In the initialisation of the development process, this maximum common portion of the ML model is used as the common portion, so the leader node initiates transmission of initialisation information to each of the worker nodes specifying the use of the maximum common portion ML model. Each of the worker nodes then forms a specific local ML model using the maximum common portion as the head of the local ML model, and trains this local ML model using its own data. The results of this training (weights and model architecture information) are sent to the leader or central node; the reception of the weights and model architecture information is shown in step S102 of FIG. 1 and discussed above.

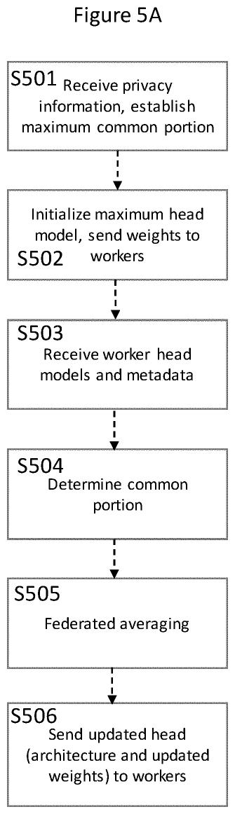

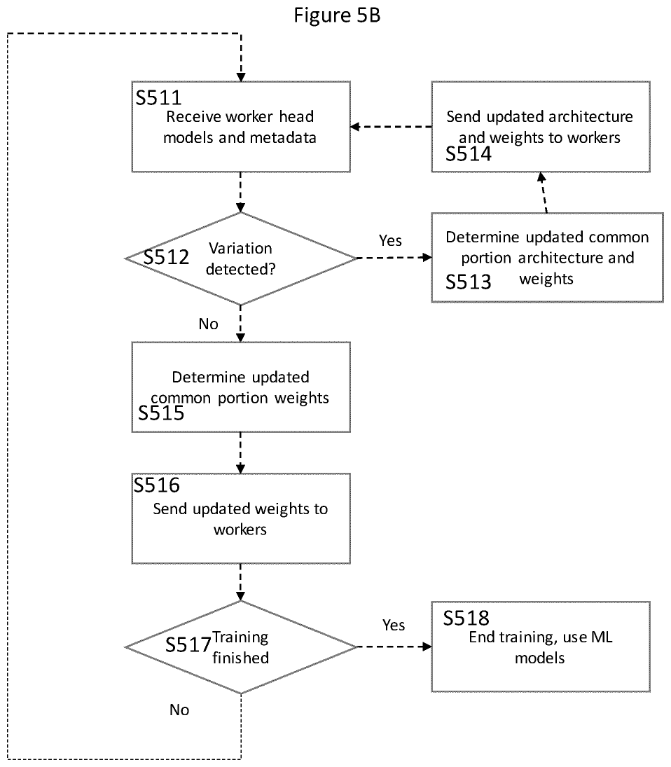

An overview of a process for developing an ML model in accordance with embodiments is shown in the flowchart of FIG. 5A and FIG. 5B (collectively FIG. 5). FIG. 5A shows a process for initialising the development of the ML model including a single round of training at the worker nodes, and FIG. 5B shows a loop for continuing the development of the ML model. The flowchart shows the process from the perspective of the leader (or central) node; in step S501, the leader node receives from the worker node the local ML model architecture privacy information and establishes the maximum common portion. In step S502, the leader node sends initialization information to the worker nodes, in the embodiment of FIG. 5 this initialization information includes starting weights for the head of the ML models (the maximum common portion). The worker nodes then train their respective local ML models, and share the head models (weights and model architecture information for part of their respective trained local ML model) with the leader node, which receives the head models in S503. In the embodiment of FIG. 5, the worker nodes also share metadata with the leader node. At step S504, the leader node determines a common portion of the parts of the trained local ML models that is useable by all of the plurality of worker nodes. Subsequently, at step S505, the leader node uses federated averaging to determine an updated common (global) portion. At step S506, the updated common portion is sent to the worker nodes (that is, the architecture and weights are sent to the worker nodes). The process may end at this point, however as a single round of training by the worker nodes has been completed, typically additional rounds of training are performed. The additional rounds of training are shown in FIG. 5B; the process may continue from step S506 of FIG. 5A to step S511 of FIG. 5B.

In step S511 of FIG. 5B, the leader node receives the head models and metadata, as in step S503. Subsequently, at S512, the leader node determines whether a variation in a model architecture from among the model architectures of the trained local ML models (of the worker nodes) has taken place. Where variation is detected (S512-Yes) the determination of a common portion comprises determining the model architecture and weights for the common portion (S513), and then sending the architecture and weights to the worker nodes (S514). Alternatively, where no variation is detected (S512-No), the determination of a common portion comprises determining updated weights for the common portion (S515), with the architecture remaining the same. The updated weights are then sent back to the workers (S516). As mentioned above, the process may comprise multiple rounds of training by the worker nodes, each of which may comprise multiple epochs of training at each worker node (potentially different numbers of epochs at different worker nodes) before updated trained local ML model information is sent to the leader node. At step S517, it is determined whether the training of the local ML models is complete; this determination may be made based on a test of the performance of the local ML models, based on a certain number of epochs of training having been completed, or in any other suitable way as will be known to those skilled in the art. If it is determined that the training is complete (S517-Yes), then the training ends and the local ML models may be used by the worker nodes (S518). Alternatively, if it is determined that the training is not finished (S517-No), then the worker nodes may further train their respective local ML models and send updated data to the leader node; the leader node then receives this updated data at step S511, as shown in FIG. 5B.

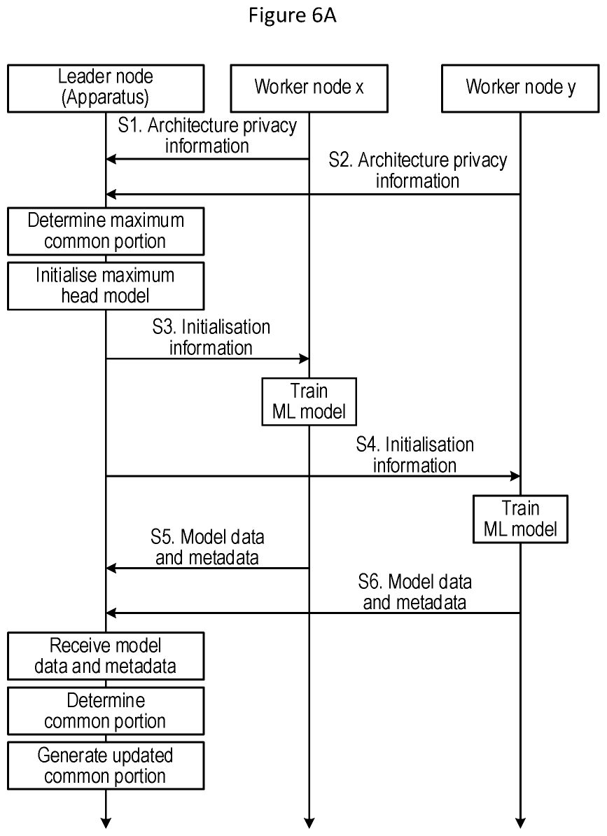

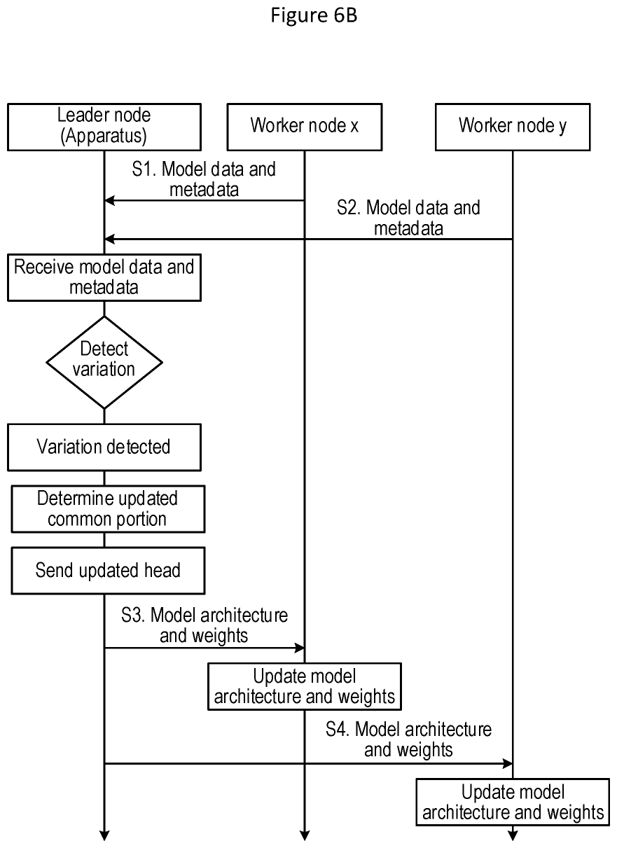

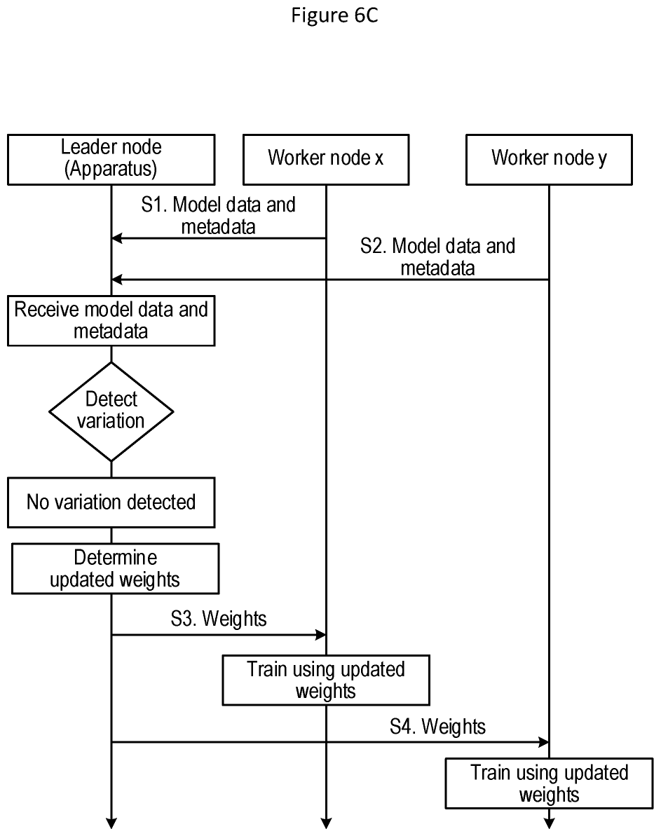

A process for developing a ML model in accordance with embodiments is illustrated in the signalling diagram of FIG. 6A, FIG. 6B and FIG. 6C (collectively FIG. 6). FIG. 6 shows the sending of data between a leader node and two worker nodes (here labelled x and y, and collectively referred to as the plurality of worker nodes). FIG. 6A shows the initialisation of the development process, and FIG. 6B and FIG. 6C show how the process may proceed depending on whether or not variation of a model architecture from among the model architectures of the trained local ML models (of the worker nodes) has taken place.

In step S1 of FIG. 6A, worker node x sends local ML model architecture privacy information to the leader node; worker node y performs the same process in step S2. The leader node then determines a maximum common portion, initialises the ML model and transmits the initialisation information to worker node x (in step S3 of FIG. 6A) and worker node y (in step S4). Worker node x and worker node y then perform a round of training (of one or more epochs) on their local ML models, and each send weights and model architecture information for part of a trained local ML model to the leader node in steps S5 and S6 of FIG. 6A respectively. The leader node then receives the weights and model architecture information from the worker nodes x and y, determines a common portion of the parts of trained local ML models, generates an updated common portion (for example using federated averaging), and sends the updated common portion back to the worker nodes x and y (not shown).

The process then continues according to one of FIG. 6B and FIG. 6C. FIG. 6B shows the process where a variation in a model architecture from among the model architectures of the trained local ML models (of the worker nodes) has taken place, and FIG. 6C shows the process where no variation has taken place. In both FIG. 6B and FIG. 6C, the leader node receives weights and model architecture information for part of a trained local ML model from worker node x (see step S1 of FIG. 6B and FIG. 6C) and worker node y (see step S2). The leader node then detects a variation in the model architectures and determines an updated common (global) portion. In FIG. 6B, where a variation is detected, the leader node transmits updated architecture and weights to the worker nodes x (see step S3 of FIG. 6B) and y (see step S4). By contrast, in FIG. 6C where no variation is detected, the leader node transmits updated weights to the worker nodes x (see step S3 of FIG. 6C) and y (see step S4).

Embodiments allow federation between worker nodes using heterogenous ML models (relating to data having heterogenous features and distributions), and therefore allows a broader range of applications for FL than existing techniques. Further, as the leader can modify the portion of the ML models of the worker nodes that is common as necessary, the systems are able to dynamically adapt to changes in the nodes and/or operating environment.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for developing a Machine Learning, ML, model, the method comprising:
receiving, at a leader computing device from each of a plurality of worker computing devices, weights and model architecture information for part of a trained ML model;
determining, at the leader computing device, a common portion of the parts of trained ML models that is useable by all of the plurality of worker computing devices;
generating, at the leader computing device, an updated common portion of the ML model using the common portion of the parts of trained ML models and the weights and model architecture information received from each of the plurality of worker computing devices; and
initiating transmission of the generated updated common portion of the ML model from the leader computing device to the worker computing devices.

2. The method of claim 1, further comprising, prior to receiving the weights and model architecture information for the parts of trained ML models from the worker computing devices:
receiving, at the leader computing device from the plurality of worker computing devices, ML model architecture privacy information;
determining, at the leader computing device, a maximum common portion of the ML model that is useable by all of the plurality of worker computing devices, using the ML model architecture privacy information; and
initiating transmission of initialization information for the maximum common portion of the ML model to all of the plurality of worker computing devices.

3. The method of claim 1, wherein the step of determining the common portion of the ML models comprises detecting a variation in a model architecture from among the model architectures of the trained ML models.

4. The method of claim 3, wherein, if the variation is detected, the updated common portion of the ML model distributed to the worker computing devices comprises weights and model architecture information.

5. The method of claim 3, wherein, if the variation is not detected, the updated common portion of the ML model distributed to the worker computing devices comprises weights.

6. The method of claim 1, further comprising receiving, at the leader computing device from each of the plurality of worker computing devices, metadata.

7. The method of claim 6, wherein the metadata is used by the leader computing device when determining the common portion of the parts of trained ML models that may be used by all of the plurality of worker computing devices.

8. The method of claim 6, wherein the metadata comprises one or more of:
resource availability information;
validation information;
updated model architecture privacy information; and
notification of a variation in a model architecture from among the model architectures of the trained ML models.

9. The method of claim 1, wherein the updated common portion of the ML model is generated using federated averaging.

10. The method of claim 1, wherein the weights and model architecture information the leader computing device receives from each of the plurality of worker computing devices is weights and model architecture information of part of a trained ML model that has been trained by a given worker computing device using data private to the given worker computing device.

11. The method of claim 1, wherein the updated common portion of the ML model comprises the output layer of the ML model.

12. The method of claim 1, further comprising, by each of the worker computing devices, using the updated common portion of the ML model as part of a worker specific ML model, wherein each worker specific ML model is used to provide suggested actions for an environment.

13. The method of claim 12, wherein the environment is one or more base stations in a communications network, or wherein the environment is one or more servers in a data center.

14. The method of claim 12, further comprising modifying the environment based on the suggested actions.

15. The method of claim 1, wherein the trained ML models are trained local ML models and the updated common portion is an updated common global portion.

16. A leader computing device configured to develop a Machine Learning, ML, model, the leader computing device comprising processing circuitry and a memory containing instructions executable by the processing circuitry, whereby the leader computing device is operable to:
receive, from each of a plurality of worker computing devices, weights and model architecture information for part of a trained ML model;
determine a common portion of the parts of trained ML models that is useable by all of the plurality of worker computing devices;
generate an updated common portion of the ML model using the common portion of the parts of trained ML models the weights and model architecture information from each of the plurality of worker computing devices; and
initiate transmission of the updated common portion of the ML model to the worker computing devices.

17. The leader computing device of claim 16, further configured to, prior to receiving the weights and model architecture information for the parts of trained ML models from the worker computing devices:
receive, from the plurality of worker computing devices, ML model architecture privacy information;
determine a maximum common portion of the ML model that is useable by all of the plurality of worker computing devices, using the ML model architecture privacy information; and
initiate transmission of initialization information for the maximum common portion of the ML model to all of the plurality of worker computing devices.

18. The leader computing device of claim 16, wherein the determination of the common portion of the ML models comprises detection of a variation in a model architecture from among the model architectures of the trained ML models.

19. The leader computing device of claim 18, further configured, if the variation is detected, to include weights and model architecture information in the updated common portion of the ML model distributed to the worker computing devices.

20. The leader computing device of claim 18, further configured, if the variation is not detected, to include weights in the updated common portion of the ML model distributed to the worker computing devices.

21. The leader computing device of claim 16, further configured to receive, from each of the plurality of worker computing devices, metadata.

22. The leader computing device of claim 21, further configured to use the metadata to determine the common portion of the parts of trained ML models that may be used by all of the plurality of worker computing devices.

23. The leader computing device of claim 21, wherein the metadata comprises one or more of:
resource availability information;
validation information;
updated model architecture privacy information; and
notification of a variation in a model architecture from among the model architectures of the trained ML models.

24.-27. (canceled)

28. A system comprising the leader computing device of claim 16, further comprising one or more worker computing devices, wherein each of the one or more worker computing devices is configured to use the updated common portion of the ML model as part of a worker specific ML model, and to use the worker specific ML model to provide suggested actions for an environment.

29. (canceled)

30. (canceled)

31. A leader computing device configured to develop a Machine Learning, ML, model, the leader computing device comprising:
a receiver configured to receive, from each of a plurality of worker computing devices, weights and model architecture information for part of a trained ML model;
a determiner configured to determine a common portion of the parts of trained ML models that is useable by all of the plurality of worker computing devices;
a generator configured to generate an updated common portion of the ML model using the common portion of the parts of trained ML models and the weights and model architecture information from each of the plurality of worker computing devices; and
a transmitter configured to initiate transmission of the updated common portion of the ML model to the worker computing devices.

32. A computer program product comprising a non-transitory computer-readable medium storing a computer program comprising instructions which, when executed on processing circuitry, cause the processing circuitry to perform a method in accordance with claim 1.
